(19) United States
(12) Patent Application Publication
(10) Pub. No.: US 2026/0162452 A1
(43) Pub. Date: Jun. 11, 2026

(54) MAPPING SCHEMATIC DIAGRAM ONTO IMAGE

(71) Applicant: Microsoft Technology Licensing, LLC, Redmond, WA (US)

(72) Inventors: Benjamin Eliot LUNDELL, Seattle, WA (US); Harpreet Singh SAWHNEY, Kirkland, WA (US); Dmitry Petrovich ANDREYCHUK, Redmond, WA (US); Xinshuang LIU, La Jolla, CA (US)

(73) Assignee: Microsoft Technology Licensing, LLC, Redmond, WA (US)

(21) Appl. No.: 18/977,240

(22) Filed: Dec. 11, 2024

(51) Int. Cl. G06V 30/148; G06F 16/3329; G06V 30/16

(52) U.S. Cl. CPC G06V 30/153; G06F 16/3329; G06V 30/16

(57) ABSTRACT

A computing system including an imaging sensor, a display device, and one or more processing devices. The processing devices receive a schematic diagram, and, at an optical character recognition (OCR) machine learning (ML) model, extract text labels from the schematic diagram. At a line detection ML model, the processing devices extract reference lines from the schematic diagram and compute schematic annotation pairs that each include a text label and a reference line endpoint. The processing devices receive a first image from the imaging sensor, and, at an image matching ML model, compute a multi-point mapping between the reference line endpoints and mapped endpoints included in the first image. By executing an image segmentation ML model, the processing devices identify segmented device components within the first image based at least in part on the multi-point mapping. The processing devices compute a segmented view and output the segmented view for display.

### BACKGROUND

Users who are operating, assembling, disassembling, or performing maintenance on devices often refer to user manuals that include schematic images of those devices. In a schematic image, labels are assigned to the different components of a device. These labels may accordingly let the user identify the different components of a physical device.

Referring to a user manual when working with a device may be time-consuming and cumbersome. For example, a user may have to repeatedly switch between looking at a user manual and at a physical device. In addition, the user manual is limited in the number of different views of the device it can show in the schematic diagrams it includes. When the user views the physical device at an angle not represented in the schematic diagrams, or when the device has some configuration not shown in those schematic diagrams (e.g., a partially disassembled configuration), the user may have difficulty locating device components.

### SUMMARY

According to one aspect of the present disclosure, a computing system is provided, including an imaging sensor, a display device, and one or more processing devices. The one or more processing devices are configured to receive a schematic diagram. At an optical character recognition (OCR) machine learning (ML) model, the one or more processing devices are further configured to extract a plurality of text labels from the schematic diagram. At a line detection ML model, the one or more processing devices are further configured to extract a plurality of reference lines associated with the text labels from the schematic diagram. The one or more processing devices are further configured to compute a plurality of schematic annotation pairs that each include a text label of the plurality of text labels and a reference line endpoint located at an opposite end, relative to the text label, of a corresponding reference line of the plurality of reference lines. The one or more processing devices are further configured to receive a first image from the imaging sensor. At least in part by executing an image matching ML model, the one or more processing devices are further configured to compute a multi-point mapping between the reference line endpoints and respective mapped endpoints included in the first image. At least in part by executing an image segmentation ML model, the one or more processing devices are further configured to identify a plurality of segmented device components within the first image based at least in part on the multi-point mapping. The one or more processing devices are further configured to compute a segmented view of the first image that depicts one or more of the segmented device components in a visually distinguishable manner. The one or more processing devices are further configured to output the segmented view for display at the display device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including one or more processing devices configured to receive a schematic diagram and generate a segmented view of a device, according to one example embodiment.

FIG. 2 shows an example schematic diagram including a plurality of text labels and reference lines associated with respective device components, according to the example of FIG. 1.

FIG. 3 shows an example view of a tablet computing device imaging a physical device, according to the example of FIG. 1.

FIG. 4 shows an example view of a head-mounted display device imaging a physical device, according to the example of FIG. 1.

FIG. 5 schematically shows the computing system when the one or more processing devices are configured to compute a multi-point mapping, according to the example of FIG. 1.

FIG. 6 schematically shows an example segmented view that includes a plurality of rendered two-dimensional (2D) masks overlaying respective segmented device components, according to the example of FIG. 1.

FIG. 7 schematically shows the computing system in an example in which the one or more processing devices are configured to modify a dynamic segmented view in response to user input, according to the example of FIG. 1.

FIG. 8 schematically shows the computing system in an example in which the one or more processing devices are configured to receive, an image sequence including a plurality of images, according to the example of FIG. 1.

FIG. 9 schematically shows the computing system when the one or more processing devices are configured to compute the plurality of rendered 2D masks, according to the example of FIG. 1.

FIG. 10 schematically shows an imaging sensor, a plurality of three-dimensional (3D) masks, and a rendered 2D mask, according to the example of FIG. 9.

FIG. 11 schematically shows the computing system when the one or more processing devices perform endpoint remapping during computation of the segmented view, according to the example of FIG. 8.

FIG. 12 schematically shows a schematic diagram and an image, along with an epipolar line through the image, according to the example of FIG. 11.

FIG. 13 schematically shows the computing system when endpoint remapping is performed during the computation of an additional segmented view that occurs later in the image sequence, according to the example of FIG. 11.

FIG. 14 schematically shows the computing system in an example in which the one or more processing devices are configured to further process the segmented view to identify a defect in a segmented device component, according to the example of FIG. 1.

FIG. 15A shows a flowchart of a method for use with a computing system to generate and display a segmented view of a physical device, according to the example of FIG. 1.

FIGS. 15B-15H show additional steps of the method of FIG. 15A that may be performed in some examples.

FIG. 16 shows a schematic view of an example computing environment in which the computing system of FIG. 1 may be instantiated.

### DETAILED DESCRIPTION

Image segmentation has been used in some previous approaches to assisting users in device part identification. In these previous approaches, machine learning (ML) models have been trained to identify the boundaries between device components. For example, these ML models may output bounding boxes or image masks associated with the identified components of a device depicted in an input image. In addition, ML models have been used to perform image recognition on device components and assign labels to them. The ML models that have been used for image segmentation and part recognition include models that are specialized for performing computer vision tasks, such as Florence-2. Alternatively, such segmentation tasks may be performed at a multimodal large language model (LLM). The LLM may, in such examples, receive an input image along with a prompt instructing the LLM to identify the locations of one or more device components depicted in that image.

When applied to the task of part recognition in schematic diagrams, existing approaches based on computer vision models and multimodal LLMs tend to have low reliability. The ML models used in these previous approaches are typically trained with schematic diagrams as only a small portion of their training data. Accordingly, such ML models frequently have difficulty matching schematically depicted device components to accurate locations in photographs. This difficulty may occur as a result of differences in appearance between schematic depictions of device components and photographs of the same or similar components. In addition, components may have highly device-specific appearances that do not appear in the training data of the ML model. Accordingly, existing ML models are frequently unable to accurately and consistently locate device components in images based on schematic diagrams.

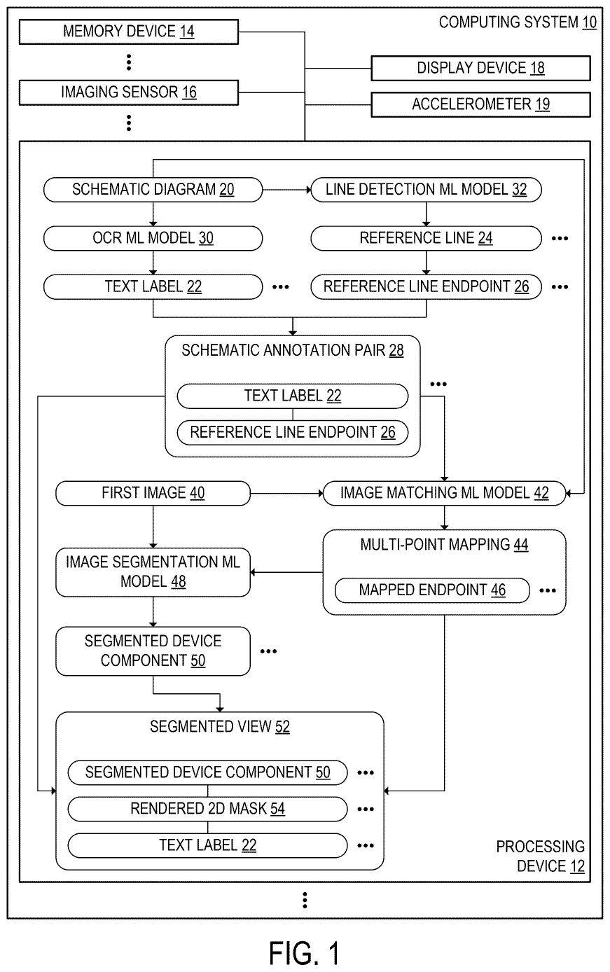

In order to address the above difficulties, a computing system 10 is provided, as depicted schematically in FIG. 1 according to one example embodiment. The computing system 10 includes one or more processing devices 12 and one or more memory devices 14. The one or more processing devices 12 may, for example, include one or more central processing units (CPUs), graphics processing units (GPUs), neural processing units (NPUs), and/or other specialized hardware accelerators. The one or more memory devices 14 may, for example, include one or more volatile memory devices and one or more non-volatile storage devices.

The computing system 10 further includes an imaging sensor 16. For example, the imaging sensor 16 may be an RGB camera or an infrared camera. Multiple different imaging sensors 16 may be included in the computing system 10 in some examples. In addition, the computing system 10 includes a display device 18 configured to display a graphical user interface (GUI) to a user. Other sensors and/or other output devices may also be included in the computing system 10 in some examples. For example, the computing system 10 may include one or more touch sensors and/or microphones as additional input devices. The computing system 10 may further include one or more accelerometers 19 configured to collect pose data of a computing device or sensor included in the computing system 10. In some examples, the computing system 10 may also include one or more speakers and/or haptic feedback devices as additional output devices.

In some examples, the one or more processing devices 12 and/or the one or more memory devices 14 may include a plurality of physical components distributed among a plurality of different physical computing devices. For example, the one or more processing devices 12 and/or the one or more memory devices 14 may be included in a networked system of physical computing devices located in a data center. Portions of the functionality of the one or more processing devices 12 and/or the one or more memory devices 14 may additionally or alternatively be performed at one or more client computing devices. In some examples, a client computing device included in the computing system 10 may have a thin-client configuration in which the imaging sensor 16 and the display device 18 are primarily performed at a thin client device (e.g., a head-mounted display device) and processing steps are primarily performed at an offboard computing device.

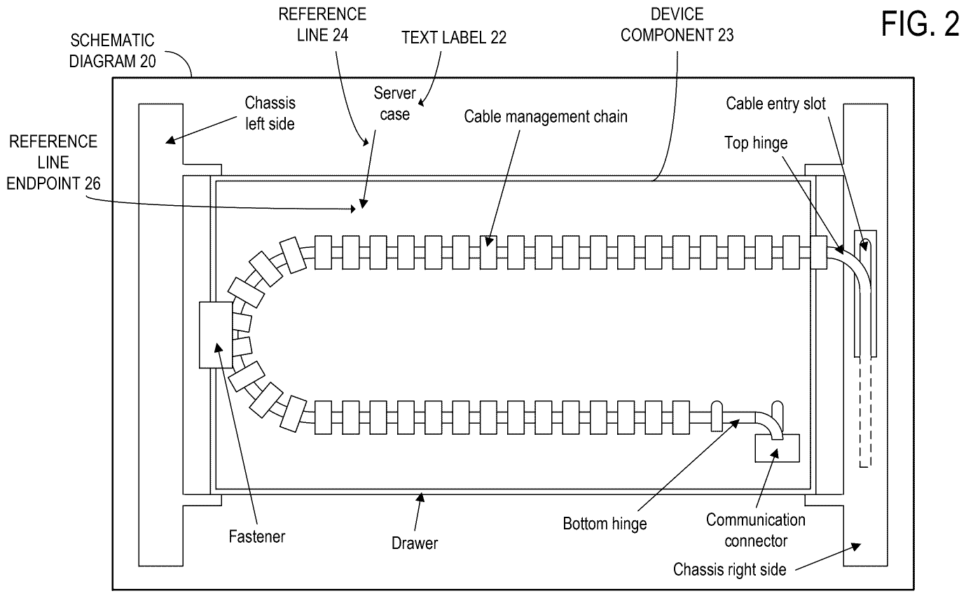

As shown in the example of FIG. 1, one or more processing devices 12 are configured to receive a schematic diagram 20. An example schematic diagram 20 is depicted in FIG. 2. In the example of FIG. 2, the schematic diagram 20 is a diagram of a front side of a server rack. The schematic diagram 20 includes a plurality of text labels 22 that provide respective names of device components 23. In addition, the schematic diagram 20 includes reference lines 24 that lead from the text labels 22 to the corresponding device components 23. Although straight reference lines are shown in FIG. 2, the reference lines 24 may curved and/or compound reference lines in other examples. The reference lines 24 have respective reference line endpoints 26 located within or on boundaries of the device components 23.

A schematic diagram 20 used with the techniques discussed herein may be a diagram of any of a wide variety of devices and structures. For example, the schematic diagram 20 may be a diagram of a mechanical device, an electrical circuit, an architectural structure, a piece of furniture, a vehicle, or some other device or structure. The terms “device” and “device component,” when used in the context of the schematic diagram 20, respectively refer to an object depicted in the schematic diagram 20 and to a component thereof. In the schematic diagram 20, the device components 23 are arranged in a manner that approximates the structure of a physical device.

Returning to the example of FIG. 1, the one or more processing devices 12 are further configured to extract the plurality of text labels 22 from the schematic diagram 20. The text labels 22 are extracted at an optical character recognition (OCR) ML model 30 that is configured to receive the schematic diagram 20 as input. The OCR ML model 30 is further configured to output the text labels 22 as text strings with respective locations within the schematic diagram 20. For example, the locations of the text labels 22 may be specified with bounding boxes.

The one or more processing devices 12 are further configured to execute a line detection ML model 32 that receives the schematic diagram 20 as input. At the line detection ML model 32, the one or more processing devices 12 are further configured to extract the plurality of reference lines 24 associated with the text labels 22 from the schematic diagram 20. For example, the DeepLSD model may be used as the line detection ML model 32.

The one or more processing devices 12 are further configured to compute a plurality of schematic annotation pairs 28. The schematic annotation pairs 28 each include a text label 22 of the plurality of text labels 22 extracted from the schematic diagram 20. In addition, each of the schematic annotation pairs 28 includes a reference line endpoint 26 located at an opposite end, relative to the text label 22, of a corresponding reference line 24 of the plurality of reference lines 24. Thus, each of the schematic annotation pairs 28 matches a text label 22 to a point located within or on a boundary of the device component 23 named in the text label 22.

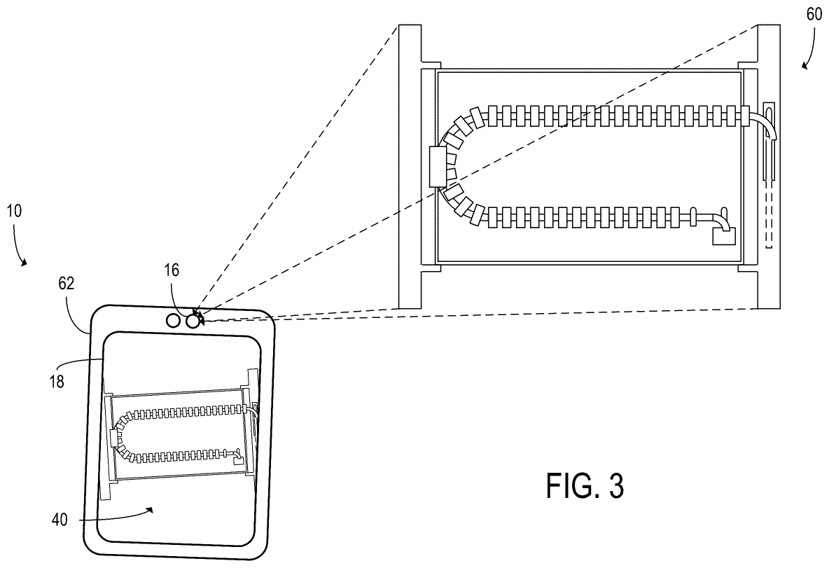

The one or more processing devices 12 are further configured to receive a first image 40 from the imaging sensor 16. FIG. 3 shows an example in which the computing system 10 includes a tablet computing device 62 in which the imaging sensor 16 is located. Via the imaging sensor 16, the tablet computing device 62 is configured to image a physical device 60 corresponding to the schematic diagram 20. The physical device 60 is a server rack in the example of FIG. 3. The tablet computing device 62 shown in the example of FIG. 3 also includes the display device 18 and is configured to display the first image 40 on the display device 18.

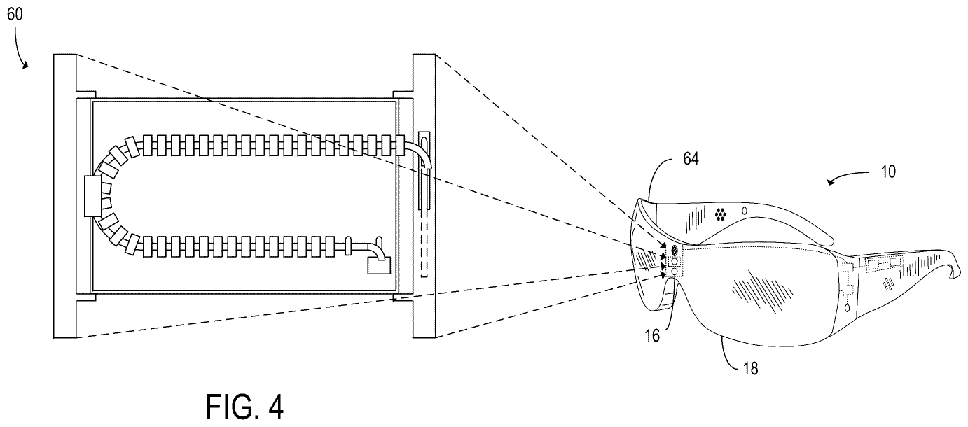

FIG. 4 schematically shows an example in which the computing system 10 includes a head-mounted display (HMD) device 64 in which the imaging sensor 16 is located. The HMD device 64 is also configured to image the physical device 60. In addition, the HMD device 64 includes a display device 18, which is shown in the example of FIG. 4 as a partially transparent near-eye display. At the display device 18, the one or more processing devices 12 may be configured to display one or more virtual objects that annotate the user's view of the physical device 60, thereby providing a mixed-reality experience to the user.

Returning to the example of FIG. 1, the one or more processing devices 12 are further configured to execute an image matching ML model 42. For example, the Robust Matching (RoMa) model may be used as the image matching ML model 42. The image matching ML model 42 is configured to receive the first image 40 and the schematic diagram 20 as input. At least in part by executing the image matching ML model 42, the one or more processing devices 12 are configured to compute a multi-point mapping 44 between the reference line endpoints 26 included in the schematic annotation pairs 28 and respective mapped endpoints 46 included in the first image 40. The multi-point mapping 44 therefore includes a plurality of mapped endpoints 46 in the first image 40 that correspond to the reference line endpoints 26 identified in the schematic diagram 20.

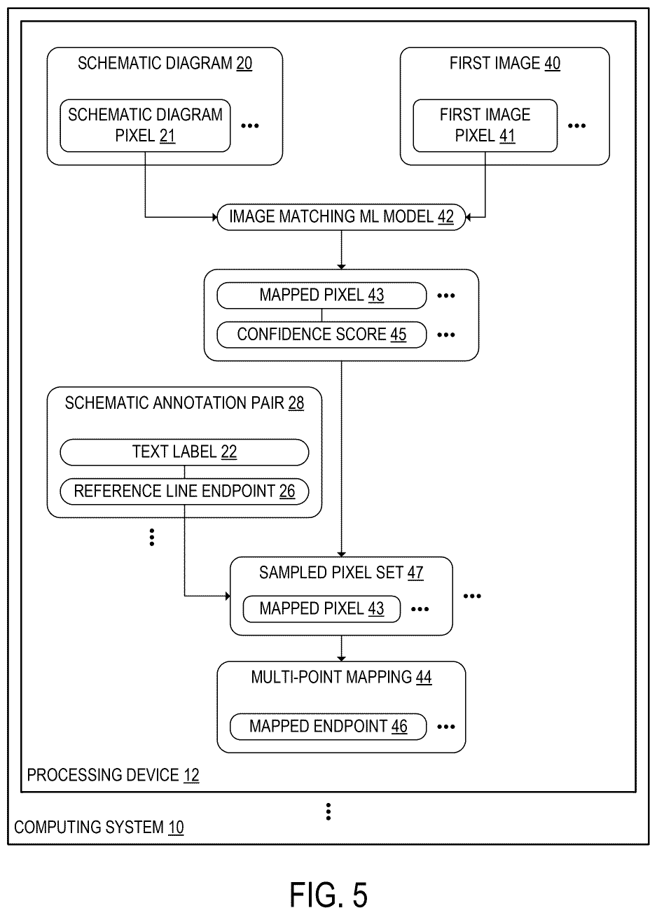

FIG. 5 schematically shows the computing system 10 in additional detail when the multi-point mapping 44 is computed. Computing the multi-point mapping 44 includes an image mapping operation and an endpoint mapping operation. When the one or more processing devices 12 compute the multi-point mapping 44, the image matching ML model 42 may be configured to receive each of the schematic diagram pixels 21 included in the schematic diagram 20 and each of the first image pixels 41 included in the first image 40. The image matching ML model 42 may be further configured to compute a respective mapped pixel 43 in the first image 40 associated with each schematic diagram pixel 21 of the schematic diagram 20, along with respective confidence scores 45 of those matches.

The one or more processing devices 12 may be further configured to sample a plurality of sampled pixel sets 47, each including a respective plurality of the mapped pixels 43, according to the confidence scores 45 of those mapped pixels 43. Each of the sampled pixel sets 47 may be a set of mapped pixels 43 mapped onto the first image 40 from locations proximate to the reference line endpoints 26 in the schematic diagram 20. The one or more processing devices 12 may be further configured to compute the mapped endpoints 46 by averaging over the locations the mapped pixels 43 included in corresponding sampled pixel sets 47. Thus, the one or more processing devices 12 may be configured to increase the accuracy of the mapped endpoints 46 by averaging over a plurality of mapped pixels 43 corresponding to nearby locations in the schematic diagram 20.

The one or more processing devices 12 are further configured to execute an image segmentation ML model 48 that receives the first image 40 and the multi-point mapping 44 as input. For example, the Segment Anything Model (SAM) may be used as the image segmentation ML model 48. At the image segmentation ML model 48, the one or more processing devices 12 are further configured to identify a plurality of segmented device components 50 within the first image 40 based at least in part on the multi-point mapping 44. The segmented device components 50 correspond to the device components 23 included in the schematic diagram 20 but are instead portions of the first image 40.

When the one or more processing devices 12 execute the image segmentation ML model 48, the one or more processing devices 12 may be configured to perform a respective inferencing pass for each of the segmented device components 50. In each of the inferencing passes, the mapped endpoint 46 associated with one of the text labels 22 may be used as a positive prompt to the image segmentation ML model 48, and the mapped endpoints 46 associated with the other text labels 22 may be used as negative prompts. This prompting approach may reduce ambiguity related to the sizes of the different segmented device components 50.

The one or more processing devices 12 are further configured to compute a segmented view 52 of the first image 40 that depicts one or more of the segmented device components 50 in a visually distinguishable manner. “In a visually distinguishable manner” means that in the segmented view 52, the appearances of the one or more segmented device components 50 are visually differentiated from each other and from portions of the first image 40 other than the segmented device components 50. The one or more processing devices 12 are further configured to output the segmented view 52 for display at the display device 18.

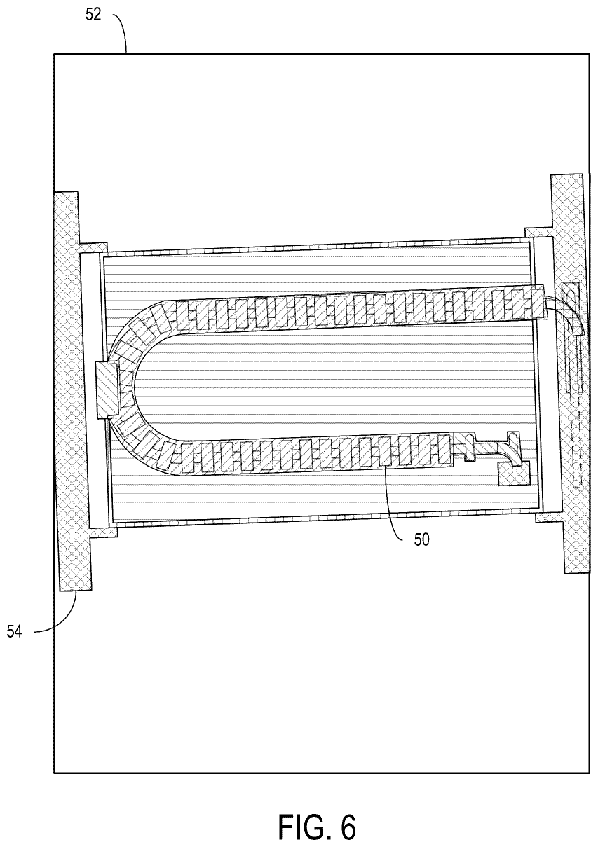

In some examples, the segmented view 52 may include a respective plurality of rendered two-dimensional (2D) masks 54 that overlay the segmented device components 50. For example, the rendered 2D masks may be partially transparent overlays located in respective regions of the first image 40 that the one or more processing devices 12 determine show the segmented device components 50. FIG. 6 schematically shows a segmented view 52 that includes a plurality of rendered 2D masks 54 overlaying a plurality of segmented device components 50 as semi-transparent layers.

In examples in which the display device 18 is a near-eye display of an HMD device 64 as in the example of FIG. 4, the rendered 2D masks 54 may be virtual objects located at respective apparent locations in the user's environment that indicate the segmented device components 50.

Additionally or alternatively to the rendered 2D masks 54, the segmented view 52 may include respective annotations of the segmented device components 50 with the text labels 22. The one or more processing devices 12 may be configured to assign the text labels 22 to the segmented device components 50 as indicated by the plurality of schematic annotation pairs 28. Since the one or more processing devices 12 are configured to map the reference line endpoints 26 to the mapped endpoints 46, and to map the mapped endpoints 46 to the segmented device components 50, each of the segmented device components 50 is associated with a respective text label 22 included in the same schematic annotation pair 28 as that reference line endpoint 26. These text labels 22 may be included in the segmented view 52.

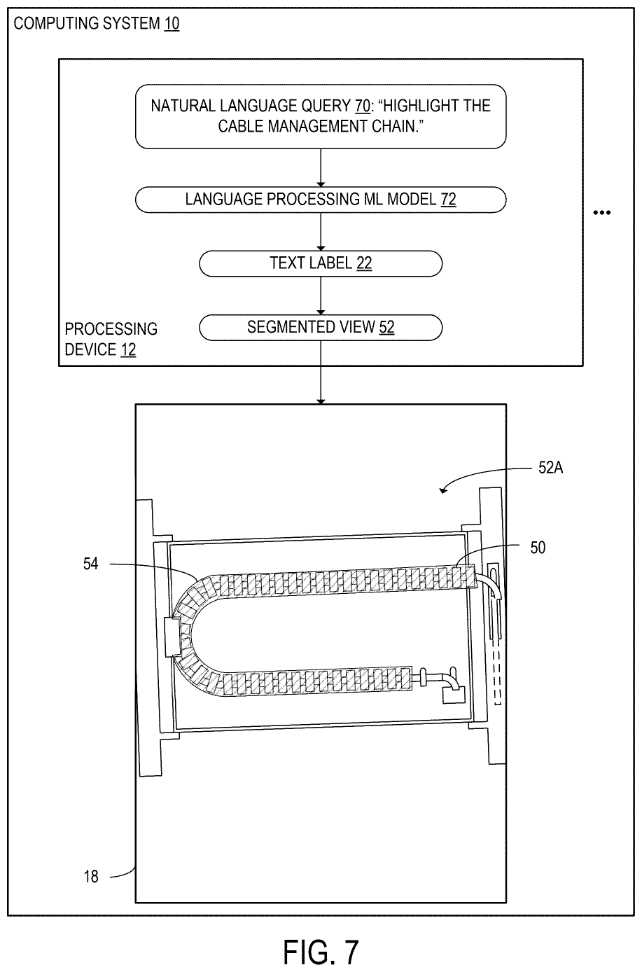

In some examples, the plurality of rendered 2D masks 54 and/or the plurality of text labels 22 are all shown concurrently in the segmented view 52. In other examples, as depicted in FIG. 7, the segmented view 52 may be a dynamic segmented view 52A that the one or more processing devices 12 are configured to modify over time to indicate different segmented device components 50. FIG. 7 schematically shows the computing system 10 when a dynamic segmented view 52A is generated at the one or more processing devices 12 and displayed at the display device 18.

In some examples, as shown in FIG. 7, the one or more processing devices 12 may be configured to modify the dynamic segmented view 52A in response to user input. The one or more processing devices 12 may be further configured to receive a natural language query 70. The user may, for example, enter the natural language query 70 at a GUI displayed at the display device 18. As another example, the natural language query 70 may be entered as a voice input. The natural language query 70 in the example of FIG. 7 is “Highlight the cable management chain.”

The one or more processing devices 12 may be further configured to input the natural language query 70 into a language processing ML model 72. For example, the language processing ML model 72 may be a multimodal LLM that is configured to process text data and audio data. At the language processing ML model 72, the one or more processing devices 12 may be further configured to match the natural language query 70 to a text label 22 of the plurality of text labels 22. In response to matching the natural language query 70 to the text label 22, the one or more processing devices are further configured to modify the segmented view 52 to visually indicate a segmented device component 50 associated with the text label 22. The dynamic segmented view 52A of FIG. 7 is modified, relative to the first image 40, by highlighting the cable management chain with a rendered 2D mask 54.

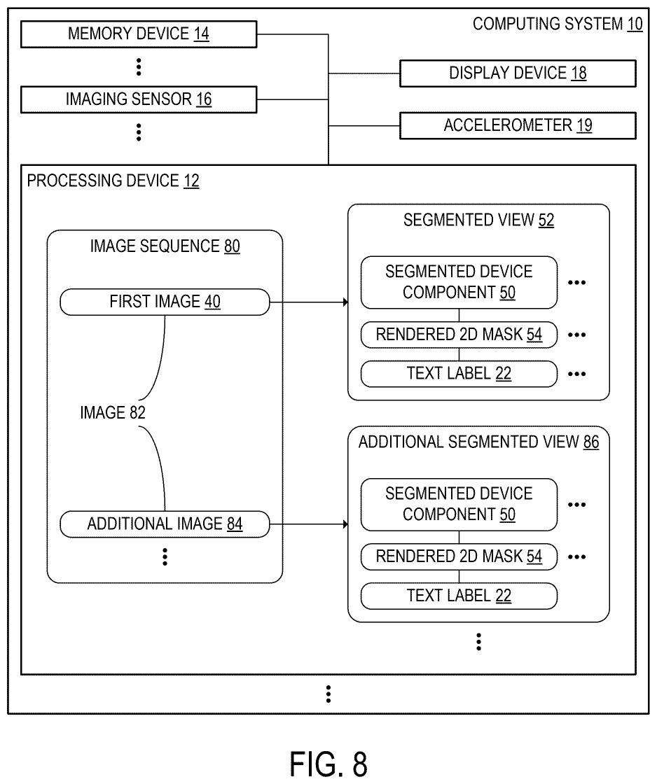

FIG. 8 schematically shows the computing system 10 in an example in which the one or more processing devices 12 are further configured to receive, from the imaging sensor 16, an image sequence 80 including a plurality of images 82. The image sequence 80 begins with the first image 40 and further includes a plurality of additional images 84. For example, the image sequence 80 may be a video of the physical device 60 captured using the imaging sensor 16.

The one or more processing devices 12 are further configured to compute an additional segmented view 86 for each of the additional images 84 included in the image sequence 80 after the first image 40. The one or more processing devices 12 are further configured to output the additional segmented views 86 for display at the display device 18. In some examples in which the image sequence 80 is a video of the physical device 60, the one or more processing devices 12 may be further configured to output the additional segmented views 86 in real time with receiving the image sequence 80. The display device 18 may accordingly present a video output in which the locations of one or more of the segmented device components 50 are tracked over time.

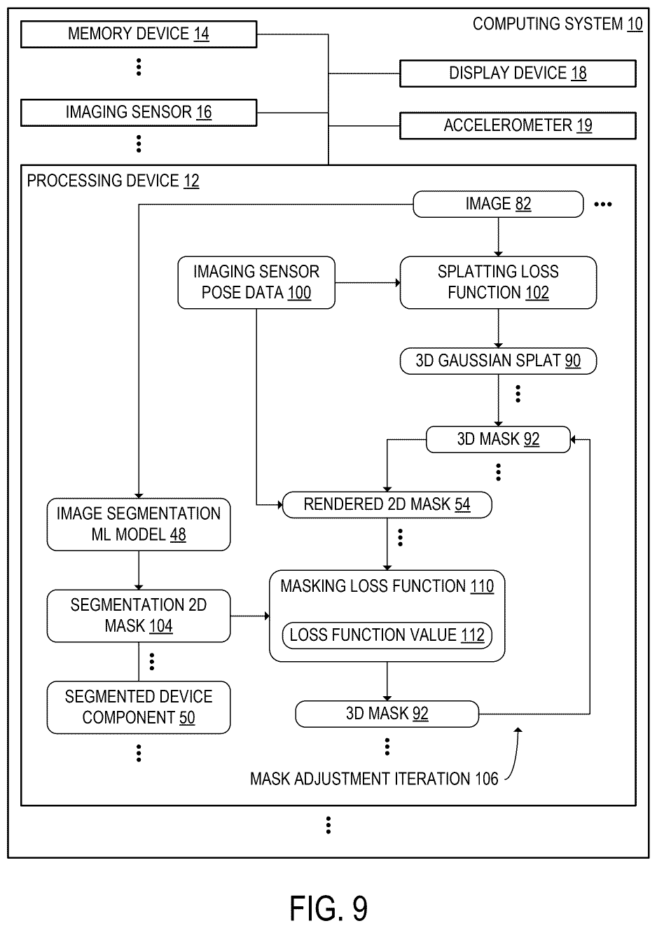

FIG. 9 schematically shows the computing system 10 during computation of the rendered 2D masks 54 included in the segmented view 52 and in an additional segmented view 86. In the example of FIG. 9, the one or more processing devices 12 are further configured to compute respective sets of 3D Gaussian splats 90 associated with the images 82 included in the image sequence 80. Each of the Gaussian splats 90 includes data that specifies local attributes of a region of an image 82. For example, a Gaussian splat 90 may include the location, extent, and surface uncertainty of a region of the image. Color data and opacity data may also be included in the Gaussian splat 90.

The one or more processing devices 12 may be configured to compute the above parameters of the Gaussian splat 90 by performing differentiable rendering from a Gaussian representation onto images 82 that have known six-degree-of-freedom (6DoF) camera poses. Thus, the computation of the Gaussian splats 90 also incorporates imaging sensor pose data 100 associated with the images 82. The imaging sensor pose data 100 may be received at least in part from the one or more imaging sensors 16 and/or the accelerometer 19. Sensor data received from the one or more imaging sensors 16 and/or the accelerometer 19 may be preprocessed at the one or more processing devices 12 to compute the imaging sensor pose data 100 as a 6DoF camera pose.

The one or more processing devices 12 may be further configured to compute Gaussian splat parameters that achieve a local minimum of a splatting loss function 102 computed between predicted color data and observed color data in each of the images 82, while also accounting for pose and visibility. For example, the following loss function may be used as the splatting loss function 102:

$$ℒ = ( 1 - λ ) {ℒ}_{1} + {λℒ}_{D - SSIM}$$

In the above equation, [symbol] ₁ is the L1 distance, [symbol] _{D-SSIM} is a Data Structural Similarity Index (D-SSIM) loss term, and λ is a constant parameter. For example, a value of λ=0.2 may be used.

For each of the images 82, the one or more processing devices 12 are further configured to compute respective 3D masks 92 based at least in part on 3D Gaussian splats 90 computed for that image 82. Each of the 3D masks 92 may, for example, include a value between 0 and 1 that is associated with a corresponding 3D Gaussian splat 90. Each 3D mask 92 may further include an identifier of a corresponding segmented device component 50.

The one or more processing devices 12 are further configured to compute the rendered 2D masks 54 based at least in part on the 3D masks 92 and the imaging sensor pose data 100. The one or more processing devices 12 may be configured to compute the rendered 2D masks 54 by projecting the 3D masks onto a virtual surface imaged by the imaging sensor 16 from the location and angle specified in the imaging sensor pose data 100 as a 6DoF camera pose.

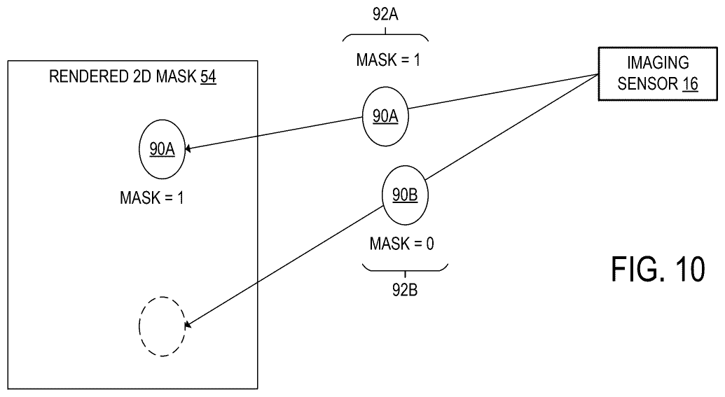

FIG. 10 schematically shows an imaging sensor 16 and a rendered 2D mask 54 computed from a plurality of 3D masks 92 and the imaging sensor pose data 100 of the imaging sensor 16. FIG. 10 depicts a first 3D mask 92A that has a value of 1 and is associated with a first Gaussian splat 90A. FIG. 9 further depicts a second 3D mask 92B that has a value of 0 and is associated with a second Gaussian splat 90B. In the rendered 2D mask 54, a projection of the first Gaussian splat 90A is displayed but a projection of the second Gaussian splat 90B is not displayed.

Returning to the example of FIG. 9, the image segmentation ML model 48 is configured to receive the image 82 and output a plurality of segmentation 2D masks 104 that indicate the segmented device components 50. The segmentation 2D masks 104 and the rendered 2D masks 54 are then used as inputs to a plurality of mask adjustment iterations 106. In each of the mask adjustment iterations 106, the one or more processing devices 12 are configured to recompute the rendered 2D masks 54 based at least in part on the plurality of 3D masks 92 and the imaging sensor pose data 100 using the projection approach discussed above.

The one or more processing devices 12 are further configured to compute a loss function value 112 of a masking loss function 110 based at least in part on the segmentation 2D masks 104 and the rendered 2D masks 54. For example, the following function may be used as the masking loss function 110:

$$loss = {{\sum }_{i , j}}_{{M}_{SAM} [ i , j ] = 0} {M}_{rendered} [ i , j ] - {{\sum }_{i , j}}_{{M}_{SAM} [ i , j ] = 1} {M}_{rendered} [ i , j ]$$

In the above example, i and j are horizontal and vertical pixel coordinates, respectively. M_{SAM} are the mask values of the segmentation 2D masks 104 and M_{rendered} are the mask values of the rendered 2D masks 54. The above loss function assigns a high loss value to a rendered 2D mask 54 when that rendered 2D mask 54 includes pixels that are present in a 3D Gaussian splat 90 but not in any of the segmentation 2D masks 104.

As an alternative to the loss function shown above, the following loss function may be used as the masking loss function 110:

$$loss = - {\sum }_{p} {M}_{SAM} ( p ) \cdot M ( p ) + ρ {\sum }_{p} ( 1 - {M}_{SAM} ( p ) ) \cdot M ( p )$$

This second masking loss function positively reinforces overlap between the segmentation 2D masks 104 and the rendered 2D masks 54. In addition, the second masking loss function negatively reinforces the assignment of mask values of 0 to pixels.

Based at least in part on the loss function value 112, each of the mask adjustment iterations 106 further includes modifying the plurality of 3D masks 92. Over the plurality of mask adjustment iterations 106, the one or more processing devices 12 may be configured to perform gradient descent over the plurality of 3D masks 92 using the loss function values 112. Thus, the one or more processing devices 12 may be configured to compute a plurality of 3D masks 92 and a corresponding plurality of rendered 2D masks 54 that approximately minimize the masking loss function 110. The rendered 2D masks 54 included in a final mask adjustment iteration 106 may be included in the segmented view 52.

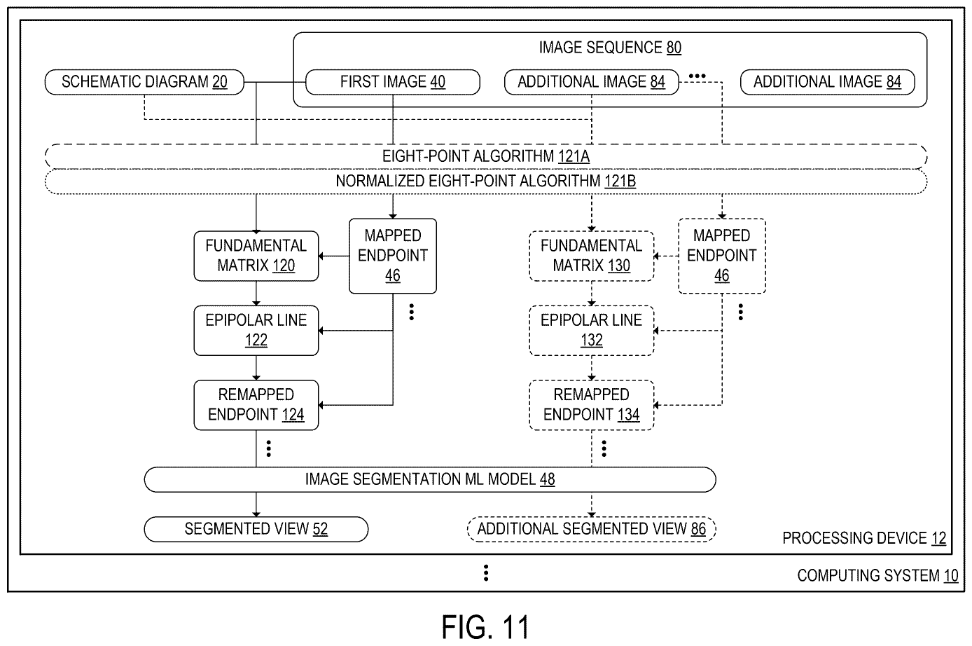

FIG. 11 schematically shows the computing system 10 when the one or more processing devices 12 perform endpoint remapping during computation of the segmented view 52. When computing the segmented view 52, the one or more processing devices 12 are further configured to compute a fundamental matrix 120 between the schematic diagram 20 and the first image 40. The fundamental matrix 120 relates corresponding points in the schematic diagram 20 and the first image 40. For example, the one or more processing devices 12 may be configured to execute an eight-point algorithm 121A or a normalized eight-point algorithm 121B to generate the fundamental matrix 120.

The fundamental matrix 120 for a pair of images 82 specifies an epipolar constraint for the pair of images 82. For each of the mapped endpoints 46 identified in the first image 40, the one or more processing devices 12 are further configured to compute a respective epipolar line 122 through that mapped endpoint 46 based at least in part on the fundamental matrix 120.

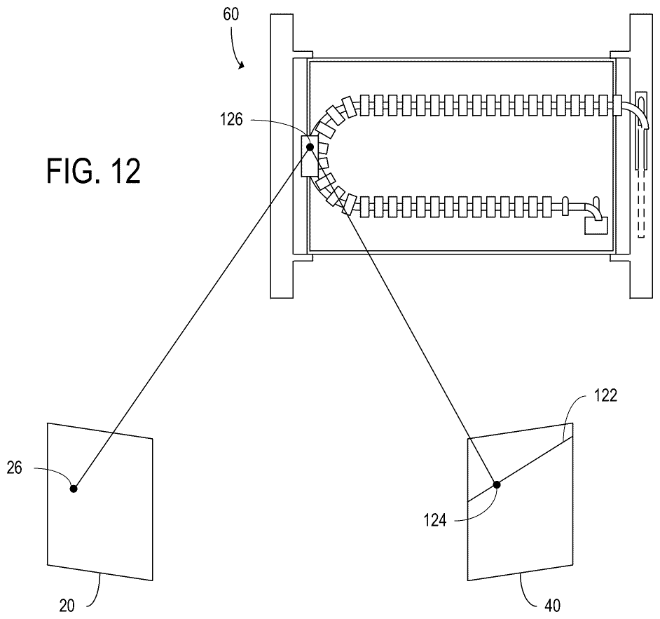

The one or more processing devices 12 are further configured to computing a plurality of remapped endpoints 124 based at least in part on the epipolar line 122. The one or more processing devices 12 are configured to constrain the remapped endpoints 124 to locations along the epipolar line 122. FIG. 12 schematically shows the schematic diagram 20 and the first image 40, along with an epipolar line 122 through the first image 40. The schematic diagram 20 includes a reference line endpoint 26 that corresponds to a physical point 126 on the physical device 60. The first image 40 includes a remapped endpoint 124 that also corresponds to the physical point 126 and is located on the epipolar line 122. By constraining remapped endpoints 124 to lie along epipolar lines 122, the one or more processing devices 12 are configured to compute more accurate remapped endpoints 124 that reflect the geometry of the physical environment in which the imaging sensor 16 is located.

Returning to the example of FIG. 11, the one or more processing devices 12 are further configured to compute the segmented view 52 at least in part at the image segmentation ML model 48 based at least in part on the remapped endpoints 124. The one or more processing devices 12 may be configured to perform a plurality of mask adjustment iterations 106 during the computation of the additional segmented view 86 to obtain the rendered 2D masks 54 it includes, as discussed above with reference to FIG. 9.

In some examples, the one or more processing devices 12 are further configured to perform epipolar-line-based endpoint remapping between the schematic diagram 20 and an additional image 84 in the image sequence 80. Thus, in such examples, the one or more processing devices 12 are further configured to compute a fundamental matrix 130 and an epipolar line 132 associated with the additional image 84. Using the epipolar line 132, the one or more processing devices 12 are further configured to compute a plurality of remapped endpoints 124 that are included in the additional segmented view 86.

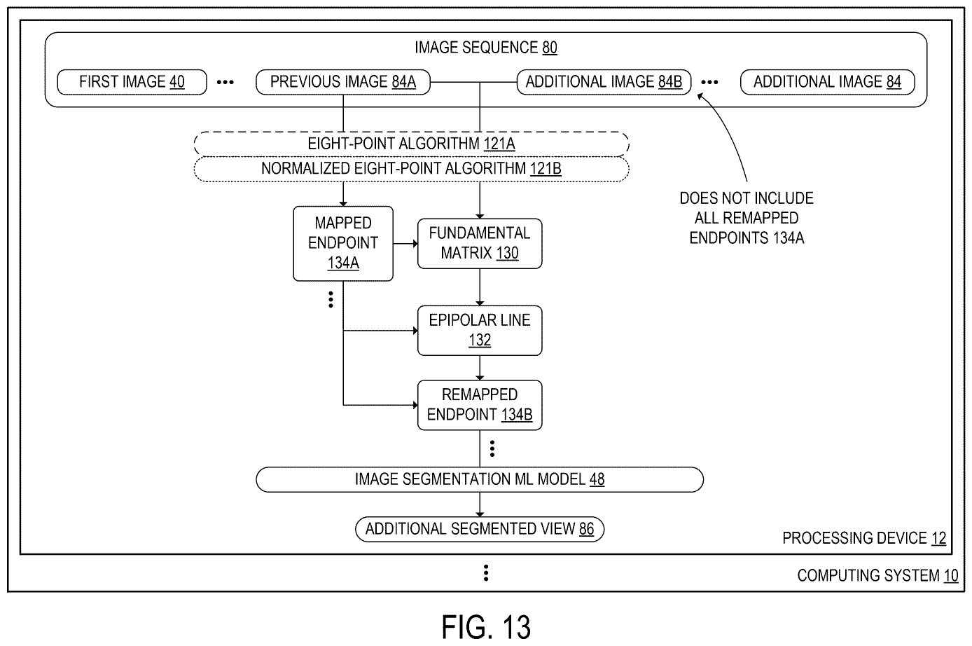

FIG. 13 schematically shows the computing system 10 when endpoint remapping is performed during the computation of an additional segmented view 86 that occurs later in the image sequence 80. For at least one of the additional images 84B included in the image sequence 80, the one or more processing devices 12 are further configured to determine that a mapped endpoint 134A of the plurality of mapped endpoints 134A included in a previous image 84A in the image sequence 80 is not included in that additional image 84B. The mapped endpoints 134A of the previous image 84A may have been computed as remapped endpoints, as shown in the example of FIG. 11. To determine that a mapped endpoint 134A is not included in the additional image 84B, the one or more processing devices 12 may be configured to determine that the mapped endpoint 134A does not occur in a multi-point mapping 44 computed for the additional image 84B. As another example, the one or more processing devices 12 may be configured to project a 3D location of the mapped endpoint 134A into a 2D imaging plane of the imaging sensor 16. The one or more processing devices 12, in such examples, may be further configured to determine whether the mapped endpoint 134A is located within a region of that 2D imaging plane that corresponds to the field of view of the imaging sensor 16.

In response to determining that the mapped endpoint 134A is not included in the additional image 84B, the one or more processing devices 12 are further configured to compute remapped endpoints 134B included in the additional segmented view 86 at least in part by mapping the mapped endpoints 134A of another image in the image sequence 80 onto the additional image 84B. This remapping may be performed using the remapping techniques discussed above with reference to FIG. 10, but with the another image in place of the schematic diagram 20. The another image that is used as the mapped endpoint source may be the previous image 84A, as shown in the example of FIG. 13, or may be subsequent to the additional image 84B in the image sequence 80. Alternatively, the another image may be located two or more images 82 away from the additional image 84B in the image sequence 80. By computing the remapped endpoints 134B by mapping points in the additional image 84B to the mapped endpoints 134A of the another image instead of to the reference line endpoints 26, the one or more processing devices 12 may be configured to generate more accurate segmentations of views of the physical device 60 that differ significantly in viewing angle from the view provided in the schematic diagram 20.

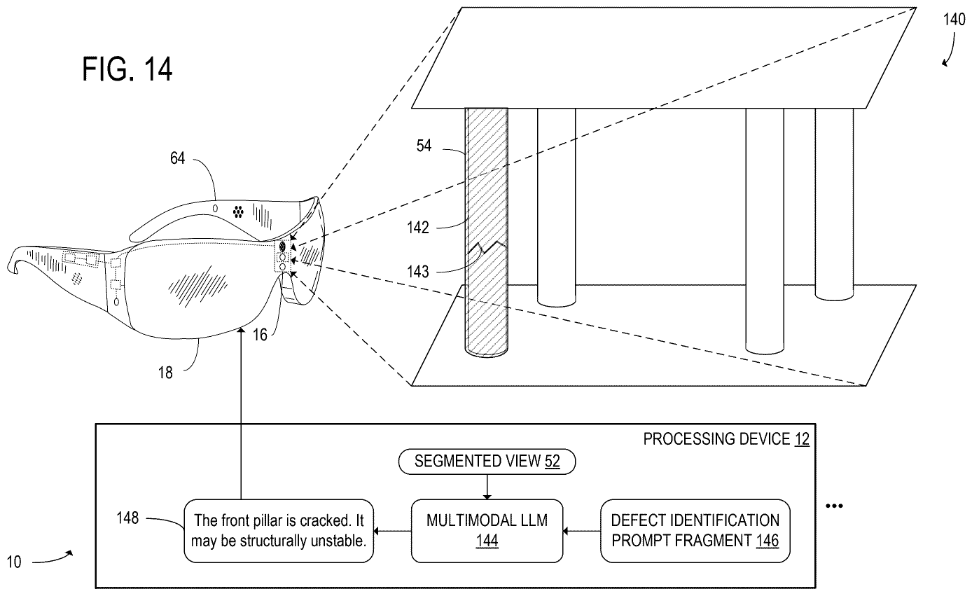

After a segmented view 52 has been generated, further computing processes in addition to display at the display device 18 may be performed on that segmented view 52. For example, as shown in FIG. 7, the segmented view 52 may be a dynamic segmented view 52A that is modified in response to user input. In addition, after the one or more processing devices 12 have identified the segmented device components 50, the one or more processing devices 12 may be further configured to perform additional image processing on those segmented device components 50, as shown in the example of FIG. 14. In the example of FIG. 14, the physical object depicted in the schematic diagram 20 is an architectural structure 140. A user views the architectural structure 140 through the partially transparent display device 18 of an HMD device 64. In the example of FIG. 14, the one or more processing devices 12 are configured to compute a segmented view 52 of the architectural structure 140 that includes a rendered 2D mask 54 overlaying a pillar 142. This segmented view 52 is displayed to the user via the display device 18.

The one or more processing devices 12, in the example of FIG. 14, are further configured to input the segmented view 52 into a multimodal LLM 144. The multimodal LLM 144 is further configured to receive a defect identification prompt fragment 146 that instructs the multimodal LLM 144 to identify one or more defects 143 in the structure depicted in the segmented view 52. A defect 143 may, for example, be a damaged component, a component installed in an incorrect location, or a component installed with an incorrect orientation. Thus, based at least in part on the identification of the segmented device components 50, the multimodal LLM 144 is configured to identify a defect 143 in a segmented device component 50 of the plurality of segmented device components 50.

The one or more processing devices 12 are further configured to output the identification 148 of the defect 143 for display at the display device 18. In the example of FIG. 14, the identification 148 of the defect 143 is an identification of a crack in the pillar 142. The identification 148 is a text output that states, “The front pillar is cracked. It may be structurally unstable.” The one or more processing devices 12 are accordingly configured to programmatically identify the defect 143 and notify the user. An audio identification of the defect 143 may additionally or alternatively be output to the user in some examples.

Although, in the example of FIG. 14, a multimodal LLM 144 is used to perform defect identification, the one or more processing devices 12 may alternatively be configured to identify a defect 143 in a physical device using a specialized computer vision ML model. In such examples, the output of the computer vision ML model may be post-processed to compute the identification 148 of the defect 143 that is output to the user. For example, the one or more processing devices 12 may be further configured to execute a separate ML model to extract a text description of the computer vision ML model output. The identification 148 of the defect 143 may alternatively be displayed to the user in a non-text form, such as additional highlighting of the rendered 2D mask 54 with a color, outline, or shading pattern that indicates that a defect 143 is present.

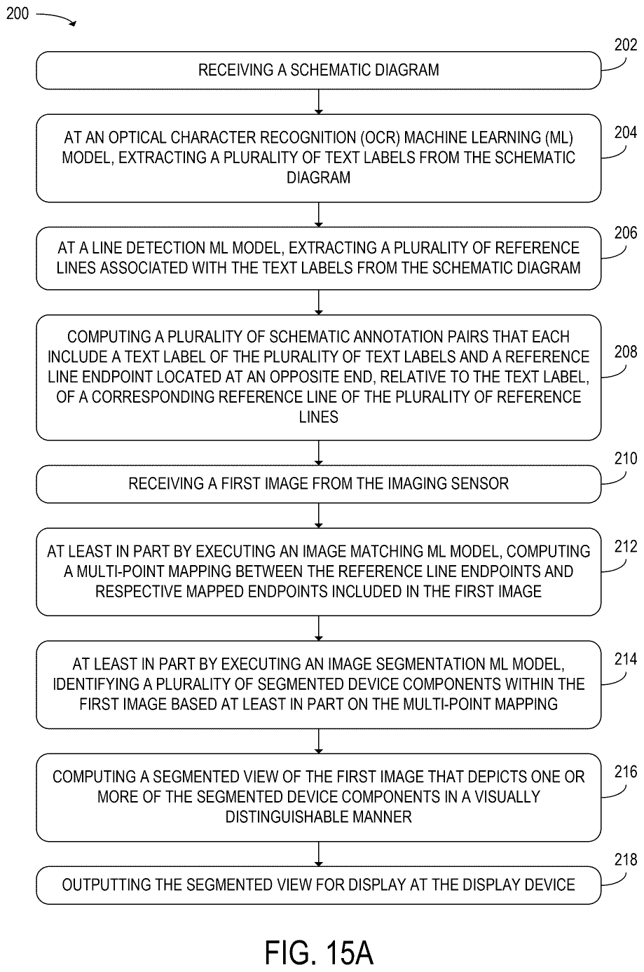

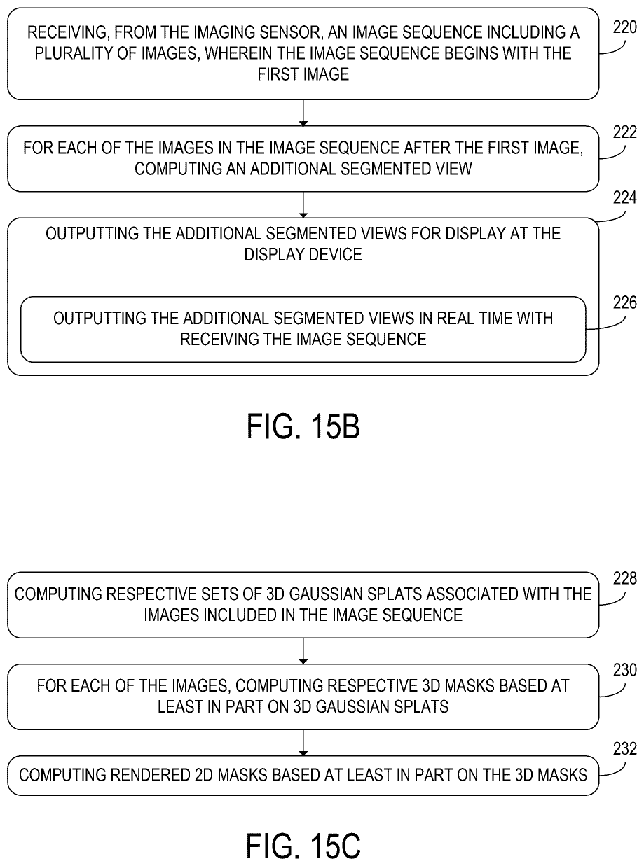

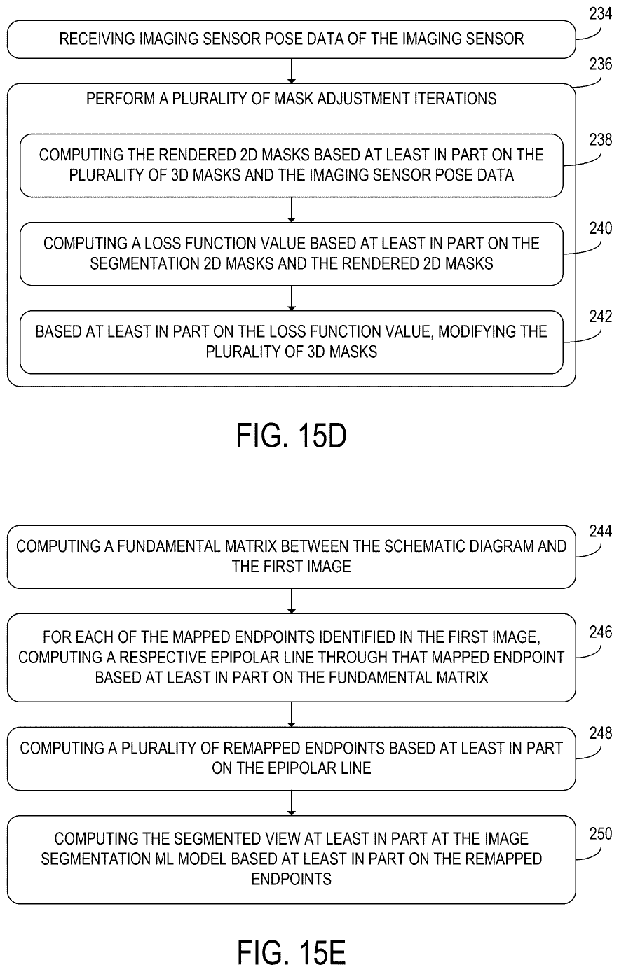

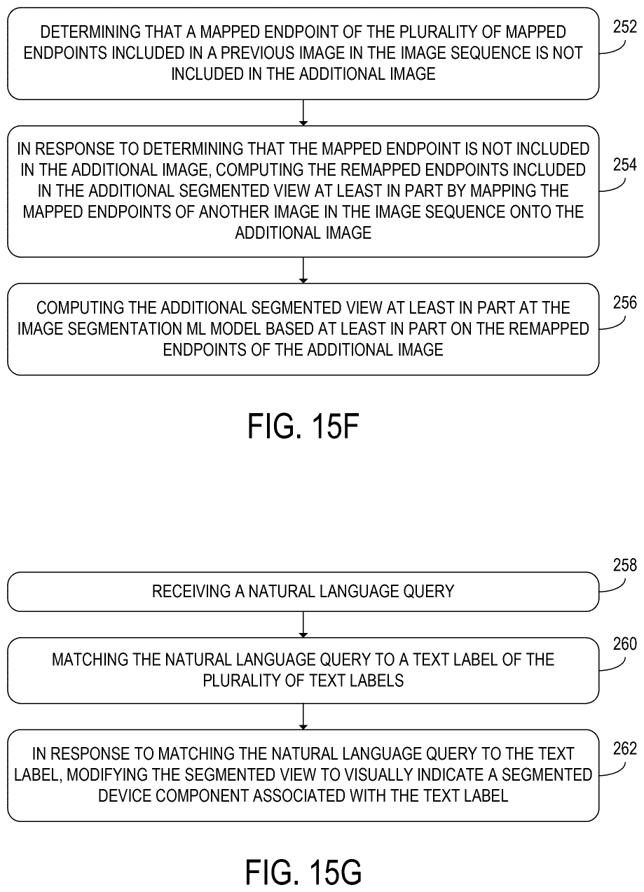

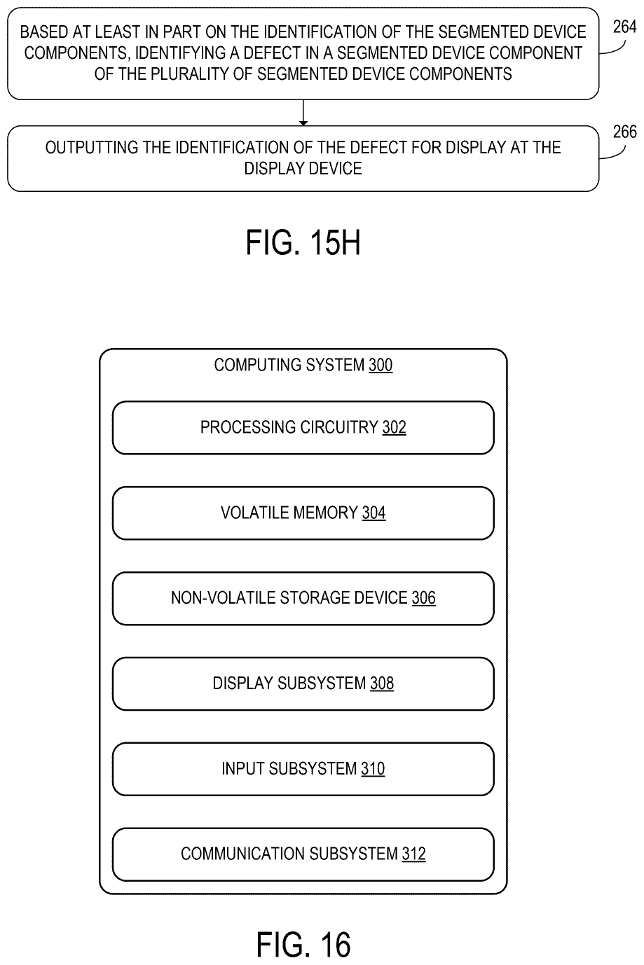

FIG. 15A shows a flowchart of a method 200 for use with a computing system to generate and display a segmented view of a physical device. The computing system at which the method 200 is performed includes an imaging sensor, a display device, and one or more processing devices. Other components, such as one or more memory devices and one or more accelerometers, may also be included in the computing system. The computing system may, for example, include a client computing device and a server computing device. The display device may, for example, be included in a smartphone, a tablet computing device, or an HMD device.

At step 202, the method 200 includes receiving a schematic diagram. The schematic diagram depicts a plurality of device components included in a physical device, in a manner that approximates the physical arrangement of those components. The schematic diagram further includes a plurality of text labels and a plurality of reference lines that link those text labels to device components.

The method 200 further includes, at step 204, extracting the plurality of text labels from the schematic diagram. The text labels are extracted at an OCR machine learning ML model. In addition, at step 206, the method 200 further includes extracting a plurality of reference lines associated with the text labels from the schematic diagram. The reference lines are extracted at a line detection ML model.

At step 208, the method 200 further includes computing a plurality of schematic annotation pairs. The schematic annotation pairs each include a text label of the plurality of text labels extracted from the schematic diagram. Each of the schematic annotation pairs further includes a reference line endpoint located at an opposite end, relative to the text label, of a corresponding reference line of the plurality of reference lines extracted from the schematic diagram. The schematic annotation pairs accordingly match the text labels to the device components indicated by those text labels.

At step 210, the method 200 further includes receiving a first image from the imaging sensor. The first image is an image of the physical object depicted in the schematic diagram.

At step 212, the method 200 further includes computing a multi-point mapping between the reference line endpoints and respective mapped endpoints included in the first image. The multi-point mapping is computed at least in part by executing an image matching ML model. For example, the image matching ML model may compute a respective mapped pixel in the first image for each of the pixels of the schematic diagram. Step 212 may further include sampling sets of schematic diagram pixels proximate to the reference line endpoints, identifying the mapped pixels corresponding to those schematic diagram pixels, and, for each of the sets of schematic diagram pixels, averaging the locations of the mapped pixels to obtain a mapped endpoint.

At step 214, the method 200 further includes identifying a plurality of segmented device components within the first image based at least in part on the multi-point mapping. Step 214 is performed at least in part by executing an image segmentation ML model. The segmented device components are regions of the first image that correspond to the device components depicted in the schematic diagram. When step 214 is performed, the image segmentation ML model may output a plurality of segmentation 2D masks that indicate the segmented device components.

At step 216, the method 200 further includes computing a segmented view of the first image that depicts one or more of the segmented device components in a visually distinguishable manner. For example, the one or more segmented device components may be depicted with outlines, colors, and/or shading patterns that visually distinguish them from other regions of the first image. In some examples, the segmented view includes respective annotations of the segmented device components with the text labels. The segmented view may include a plurality of rendered two-dimensional (2D) masks that overlay the segmented device components. When step 216 is performed, the rendered 2D masks may be computed from the segmented 2D masks output by the image segmentation ML model.

At step 218, the method 200 further includes outputting the segmented view for display at the display device.

FIGS. 15B-15H show additional steps of the method 200 that may be performed in some examples. According to the example of FIG. 15B, at step 220, the method 200 may further include receiving, from the imaging sensor, an image sequence including a plurality of images. The image sequence begins with the first image. For example, the image sequence may be recorded in a video of the physical object depicted in the schematic diagram.

At step 222, for each of the images in the image sequence after the first image, the method 200 may further include computing an additional segmented view. The additional segmented views may be computed via annotation transfer and image segmentation using the techniques discussed above for the first image. When computing the additional segmented views, data related to endpoint locations may also be transferred between from the other images included in the image sequence.

At step 224, the method 200 may further include outputting the additional segmented views for display at the display device. In some examples, at step 226, step 224 may further include outputting the additional segmented views in real time with receiving the image sequence.

FIG. 15C shows additional steps of the method 200 that may be performed in examples in which the steps of FIG. 15B are performed. At step 228, the method 200 may further include computing respective sets of 3D Gaussian splats associated with the images included in the image sequence. At step 230, for each of the images, the method 200 may further include computing respective 3D masks based at least in part on 3D Gaussian splats. In addition, at step 232, the method 200 may further include computing the rendered 2D masks based at least in part on the 3D masks. The 3D structure of the physical device and its environment are accordingly used to model the shapes and locations of the device components when generating the segmented views.

FIG. 15D shows additional steps of the method 200 that may be performed in examples in which the steps of FIG. 15C are performed. At step 234, the method 200 may further include receiving imaging sensor pose data of the imaging sensor. For example, the imaging sensor pose data may be received from an accelerometer included in the computing system. The imaging sensor pose data may indicate a 6DoF pose of the imaging sensor.

At step 236, the method 200 may further include performing a plurality of mask adjustment iterations on the rendered 2D masks. Each of the mask adjustment iterations may include, at step 238, computing the rendered 2D masks based at least in part on the plurality of 3D masks and the imaging sensor pose data. At step 240, performing a mask adjustment iteration at step 236 may further include computing a loss function value based at least in part on the segmentation 2D masks and the rendered 2D masks. At step 242, step 236 may further include modifying the plurality of 3D masks based at least in part on the loss function value. For example, gradient descent may be performed with respect to the loss function over the plurality of mask adjustment iterations. The rendered 2D masks computed in a final mask adjustment iteration may be included in the segmented view.

FIG. 15E shows additional steps of the method 200 that may be performed when computing the segmented view. At step 244, the method 200 may further include computing a fundamental matrix between the schematic diagram and the first image. The fundamental matrix may be computed based at least in part on mapped pixels output by the image matching ML model.

At step 246, for each of the mapped endpoints identified in the first image, the method 200 may further include computing a respective epipolar line through that mapped endpoint based at least in part on the fundamental matrix. At step 248, the method 200 may further include computing a plurality of remapped endpoints based at least in part on the epipolar line. The remapped endpoints are computed by adjusting the locations of the mapped endpoints to satisfy the epipolar constraint specified by the fundamental matrix. Thus, each of the remapped endpoints lies along its respective epipolar line.

At step 250, the method 200 may further include computing the segmented view at least in part at the image segmentation ML model based at least in part on the remapped endpoints. The remapped endpoints may accordingly indicate the locations of the device components in the input of the image segmentation ML model.

FIG. 15F shows additional steps of the method 200 that may be performed in examples in which the steps of FIG. 15E are performed. The steps of FIG. 15F may be performed for at least one of the additional images included in the image sequence. At step 252, the method 200 may further include determining that a mapped endpoint of the plurality of mapped endpoints included in a previous image in the image sequence is not included in that additional image.

At step 254, in response to determining that the mapped endpoint is not included in the additional image, the method 200 may further include computing the remapped endpoints included in the additional segmented view at least in part by mapping the mapped endpoints of another image in the image sequence onto the additional image. The another image may, for example, be the previous image or may be a subsequent image in the image sequence.

At step 256, the method 200 may further include computing the additional segmented view at least in part at the image segmentation ML model based at least in part on the remapped endpoints of the additional image. Thus, the mapped endpoints may be remapped using the mapped endpoints of another image in the image sequence, rather than using the schematic diagram directly, in additional images in which the physical device is shown at a significantly different angle compared to the schematic diagram.

FIG. 15G shows additional steps of the method 200 that may be performed subsequently to outputting the segmented view. At step 258, the method 200 may further include receiving a natural language query. The user may enter the natural language query at an input device included in the computing system.

At step 260, the method 200 may further include matching the natural language query to a text label of the plurality of text labels. This matching may be performed at a language processing ML model that receives the natural language query and outputs a selection of a text label from among the plurality of text labels.

At step 262, in response to matching the natural language query to the text label, the method 200 may further include modifying the segmented view to visually indicate a segmented device component associated with the text label. Thus, the segmented view in the example of FIG. 15G is a dynamic segmented view that is modified in response to user interaction.

FIG. 15H shows additional steps of the method 200 that may be performed in some examples subsequently to computing the segmented view. At step 264, based at least in part on the identification of the segmented device components, the method 200 may further include identifying a defect in a segmented device component of the plurality of segmented device components. For example, the defect may be damage to the device component or incorrect installation of the device component. The defect may be identified by performing additional ML-based image processing on one or more of the segmented device components. For example, the defect may be identified at least in part at a multimodal LLM. At step 266, the method 200 may further include outputting the identification of the defect for display at the display device. Thus, the computing system may programmatically identify and inform the user of the defect in the physical device.

Using the systems and methods discussed above, a schematic diagram of a device is used to programmatically segment a sensed image of that device. Part labels included in the schematic diagram, as well as the locations indicated by reference lines associated with those part labels, are mapped onto locations in the image to identify components of the physical device. This segmentation is displayed to the user in a segmented view. In addition, generating this mapping includes performing transformations to account for differences between the schematic diagram and the image in terms of viewing angle and distance. The components of the physical device can also be tracked across a sequence of images, such as frames of a video, over the course of which the pose of the imaging sensor changes.

By displaying a segmented view that matches components of a physical device to the components depicted in a schematic diagram, the systems and methods discussed above may assist the user with assembly, maintenance, and/or inspection of the physical device. In contrast to previous approaches to programmatic segmentation and labeling of views of physical devices, the systems and methods discussed above can more easily account for rare and highly specialized device components that are unlikely to occur in the training data sets of computer vision models. In addition, the systems and methods discussed above are more accurate than previous approaches when the physical device is viewed from a significantly different pose from that of the schematic diagram. The systems and methods discussed above may therefore perform accurate segmentation and labeling for a wider variety of images of physical devices.

The methods and processes described herein are tied to a computing system of one or more computing devices. In particular, such methods and processes can be implemented as a computer-application program or service, an application-programming interface (API), a library, and/or other computer-program product.

FIG. 16 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 16.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including an imaging sensor, a display device, and one or more processing devices. The one or more processing devices are configured to receive a schematic diagram. At an optical character recognition (OCR) machine learning (ML) model, the one or more processing devices are further configured to extract a plurality of text labels from the schematic diagram. At a line detection ML model, the one or more processing devices are further configured to extract a plurality of reference lines associated with the text labels from the schematic diagram. The one or more processing devices are further configured to compute a plurality of schematic annotation pairs that each include a text label of the plurality of text labels and a reference line endpoint located at an opposite end, relative to the text label, of a corresponding reference line of the plurality of reference lines. The one or more processing devices are further configured to receive a first image from the imaging sensor. At least in part by executing an image matching ML model, the one or more processing devices are further configured to compute a multi-point mapping between the reference line endpoints and respective mapped endpoints included in the first image. At least in part by executing an image segmentation ML model, the one or more processing devices are further configured to identify a plurality of segmented device components within the first image based at least in part on the multi-point mapping. The one or more processing devices are further configured to compute a segmented view of the first image that depicts one or more of the segmented device components in a visually distinguishable manner. The one or more processing devices are further configured to output the segmented view for display at the display device. The above features may have the technical effect of mapping the device components shown in the schematic diagram onto regions of the first image in a manner that visually indicates the regions corresponding to those device components.

According to this aspect, the one or more processing devices may be further configured to receive, from the imaging sensor, an image sequence including a plurality of images. The image sequence begins with the first image. For each of the images in the image sequence after the first image, the one or more processing devices may be further configured to compute an additional segmented view. The one or more processing devices may be further configured to output the additional segmented views for display at the display device. The above features may have the technical effect of tracking the device components of the schematic diagram across the image sequence.

According to this aspect, the segmented view and the additional segmented views may each include a respective plurality of rendered two-dimensional (2D) masks that overlay the segmented device components. The above features may have the technical effect of highlighting the regions of the first image and the additional images corresponding to the device components.

According to this aspect, the one or more processing devices may be configured to compute respective sets of 3D Gaussian splats associated with the images included in the image sequence. For each of the images, the one or more processing devices may be further configured to compute respective 3D masks based at least in part on 3D Gaussian splats. The one or more processing devices may be further configured to compute the rendered 2D masks based at least in part on the 3D masks. The above features may have the technical effect of computing the rendered 2D masks in a manner that accounts for the 3D geometry of the imaged object.

According to this aspect, for each of the images included in the image sequence, the image segmentation ML model may output a plurality of segmentation 2D masks that indicate the segmented device component. The one or more processing devices may be further configured to receive imaging sensor pose data of the imaging sensor. The one or more processing devices may be further configured to perform a plurality of mask adjustment iterations that each include computing the rendered 2D masks based at least in part on the plurality of 3D masks and the imaging sensor pose data. Each of the mask adjustment iterations may further include computing a loss function value based at least in part on the segmentation 2D masks and the rendered 2D masks. Based at least in part on the loss function value, each of the mask adjustment iterations may further include modifying the plurality of 3D masks. The above features may have the technical effect of iteratively adjusting the rendered 2D masks to obtain rendered 2D masks that more accurately match the geometry of the imaged object.

According to this aspect, when computing the segmented view, the one or more processing devices may be further configured to compute a fundamental matrix between the schematic diagram and the first image. For each of the mapped endpoints identified in the first image, the one or more processing devices may be further configured to compute a respective epipolar line through that mapped endpoint based at least in part on the fundamental matrix. The one or more processing devices may be further configured to compute a plurality of remapped endpoints based at least in part on the epipolar line. The one or more processing devices may be further configured to compute the segmented view at least in part at the image segmentation ML model based at least in part on the remapped endpoints. The above features may have the technical effect of computing remapped endpoints that accurately reflect the geometry of the physical environment.

According to this aspect, for at least one of the additional images, the one or more processing devices may be further configured to determine that a mapped endpoint of the plurality of mapped endpoints included in a previous image in the image sequence is not included in that additional image. In response to determining that the mapped endpoint is not included in the additional image, the one or more processing devices may be further configured to compute the remapped endpoints included in the additional segmented view at least in part by mapping the mapped endpoints of another image in the image sequence onto the additional image. The one or more processing devices may be further configured to compute the additional segmented view at least in part at the image segmentation ML model based at least in part on the remapped endpoints of the additional image. The above features may have the technical effect of avoiding incorrect endpoint remapping that could otherwise occur when different images in the image sequence include different sets of mapped endpoints.

According to this aspect, the one or more processing devices may be configured to output the additional segmented views in real time with receiving the image sequence. The above features may have the technical effect of providing the user with real-time identifications of the components of an imaged object.

According to this aspect, the segmented view may include respective annotations of the segmented device components with the text labels. The above features may have the technical effect of allowing the user to more easily identify the segmented device components in the segmented view.

According to this aspect, the one or more processing devices may be further configured to receive a natural language query. The one or more processing devices may be further configured to match the natural language query to a text label of the plurality of text labels. In response to matching the natural language query to the text label, the one or more processing devices may be further configured to modify the segmented view to visually indicate a segmented device component associated with the text label. The above features may have the technical effect of visually identifying a segmented device component requested by the user.

According to this aspect, the one or more processing devices may be further configured to identify a defect in a segmented device component of the plurality of segmented device components based at least in part on the identification of the segmented device components. The one or more processing devices may be further configured to output the identification of the defect for display at the display device. The above features may have the technical effect of notifying the user of a defect in a segmented device component.

According to another aspect of the present disclosure, a method for use with a computing system that includes an imaging sensor, a display device, and one or more processing devices is provided. The method includes, at the one or more processing devices, receiving a schematic diagram. At an optical character recognition (OCR) machine learning (ML) model, the method further includes extracting a plurality of text labels from the schematic diagram. At a line detection ML model, the method further includes extracting a plurality of reference lines associated with the text labels from the schematic diagram. The method further includes computing a plurality of schematic annotation pairs that each include a text label of the plurality of text labels and a reference line endpoint located at an opposite end, relative to the text label, of a corresponding reference line of the plurality of reference lines. The method further includes receiving a first image from the imaging sensor. At least in part by executing an image matching ML model, the method further includes computing a multi-point mapping between the reference line endpoints and respective mapped endpoints included in the first image. At least in part by executing an image segmentation ML model, the method further includes identifying a plurality of segmented device components within the first image based at least in part on the multi-point mapping. The method further includes computing a segmented view of the first image that depicts one or more of the segmented device components in a visually distinguishable manner. The method further includes outputting the segmented view for display at the display device. The above features may have the technical effect of mapping the device components shown in the schematic diagram onto regions of the first image in a manner that visually indicates the regions corresponding to those device components.

According to this aspect, the method may further include receiving, from the imaging sensor, an image sequence including a plurality of images. The image sequence may begin with the first image. For each of the images in the image sequence after the first image, the method may further include computing an additional segmented view. The method may further include outputting the additional segmented views for display at the display device. The above features may have the technical effect of tracking the device components of the schematic diagram across the image sequence.

According to this aspect, the segmented view and the additional segmented views may each include a respective plurality of two-dimensional (2D) masks that overlay the segmented device components. The above features may have the technical effect of highlighting the regions of the first image and the additional images corresponding to the device components.

According to this aspect, the method may further include computing respective sets of 3D Gaussian splats associated with the images included in the image sequence. For each of the images, the method may further include computing respective 3D masks based at least in part on 3D Gaussian splats. The method may further include computing the rendered 2D masks based at least in part on the 3D masks. The above features may have the technical effect of computing the rendered 2D masks in a manner that accounts for the 3D geometry of the imaged object.

According to this aspect, computing the segmented view may include computing a fundamental matrix between the schematic diagram and the first image. For each of the mapped endpoints identified in the first image, computing the segmented view may further include computing a respective epipolar line through that mapped endpoint based at least in part on the fundamental matrix. Computing the segmented view may further include computing a plurality of remapped endpoints based at least in part on the epipolar line. The segmented view may be computed at least in part at the image segmentation ML model based at least in part on the remapped endpoints. The above features may have the technical effect of computing remapped endpoints that accurately reflect the geometry of the physical environment.

According to this aspect, the additional segmented views may be output in real time with receiving the image sequence. The above features may have the technical effect of providing the user with real-time identifications of the components of an imaged object.

According to this aspect, the segmented view may include respective annotations of the segmented device components with the text labels. The above features may have the technical effect of allowing the user to more easily identify the segmented device components in the segmented view.

According to this aspect, the method may further include receiving a natural language query. The method may further include matching the natural language query to a text label of the plurality of text labels. In response to matching the natural language query to the text label, the method may further include modifying the segmented view to visually indicate a segmented device component associated with the text label. The above features may have the technical effect of visually identifying a segmented device component requested by the user.

According to another aspect of the present disclosure, a computing system is provided, including an imaging sensor, a display device, and one or more processing devices. The one or more processing devices are configured to receive a schematic diagram. At an optical character recognition (OCR) machine learning (ML) model, the one or more processing devices are further configured to extract a plurality of text labels from the schematic diagram. The one or more processing devices are further configured to detect a plurality of reference line endpoints included in the schematic diagram. The one or more processing devices are further configured to associate each of the reference line endpoints with a corresponding text label of the plurality of text labels. The one or more processing devices are further configured to receive, from the imaging sensor, an image sequence including a plurality of images. For each of the images included in the image sequence, at least in part by executing an image matching ML model, the one or more processing devices are further configured to compute a multi-point mapping between the reference line endpoints and respective mapped endpoints included in the first image. At least in part by executing an image segmentation ML model, the one or more processing devices are further configured to identify a plurality of segmented device components within the first image based at least in part on the multi-point mapping. The one or more processing devices are further configured to compute a segmented view of the first image that depicts the segmented device components and respective annotations of the segmented device components with the text labels. The one or more processing devices are further configured to output the segmented view for display at the display device. The above features may have the technical effect of mapping the device components shown in the schematic diagram onto regions of the images in a manner that visually indicates the regions corresponding to those device components.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
an imaging sensor;
a display device; and
one or more processing devices configured to:
receive a schematic diagram;
at an optical character recognition (OCR) machine learning (ML) model, extract a plurality of text labels from the schematic diagram;
at a line detection ML model, extract a plurality of reference lines associated with the text labels from the schematic diagram;
compute a plurality of schematic annotation pairs that each include:
a text label of the plurality of text labels; and
a reference line endpoint located at an opposite end, relative to the text label, of a corresponding reference line of the plurality of reference lines;
receive a first image from the imaging sensor;
at least in part by executing an image matching ML model, compute a multi-point mapping between the reference line endpoints and respective mapped endpoints included in the first image;
at least in part by executing an image segmentation ML model, identify a plurality of segmented device components within the first image based at least in part on the multi-point mapping;
compute a segmented view of the first image that depicts one or more of the segmented device components in a visually distinguishable manner; and
output the segmented view for display at the display device.

2. The computing system of claim 1, wherein the one or more processing devices are further configured to:
receive, from the imaging sensor, an image sequence including a plurality of images, wherein the image sequence begins with the first image;
for each of the images in the image sequence after the first image, compute an additional segmented view;
output the additional segmented views for display at the display device.

3. The computing system of claim 2, wherein the segmented view and the additional segmented views each include a respective plurality of rendered two-dimensional (2D) masks that overlay the segmented device components.

4. The computing system of claim 3, wherein the one or more processing devices are configured to:
compute respective sets of 3D Gaussian splats associated with the images included in the image sequence; and
for each of the images, compute respective 3D masks based at least in part on 3D Gaussian splats; and
compute the rendered 2D masks based at least in part on the 3D masks.

5. The computing system of claim 4, wherein, for each of the images included in the image sequence:
the image segmentation ML model outputs a plurality of segmentation 2D masks that indicate the segmented device components; and
the one or more processing devices are further configured to:
receive imaging sensor pose data of the imaging sensor; and
perform a plurality of mask adjustment iterations that each include:
computing the rendered 2D masks based at least in part on the plurality of 3D masks and the imaging sensor pose data;
computing a loss function value based at least in part on the segmentation 2D masks and the rendered 2D masks;
based at least in part on the loss function value, modifying the plurality of 3D masks.

6. The computing system of claim 2, wherein, when computing the segmented view, the one or more processing devices are further configured to:
compute a fundamental matrix between the schematic diagram and the first image;
for each of the mapped endpoints identified in the first image, compute a respective epipolar line through that mapped endpoint based at least in part on the fundamental matrix;
compute a plurality of remapped endpoints based at least in part on the epipolar line; and
compute the segmented view at least in part at the image segmentation ML model based at least in part on the remapped endpoints.

7. The computing system of claim 6, wherein the one or more processing devices are further configured to, for at least one of the additional images:
determine that a mapped endpoint of the plurality of mapped endpoints included in a previous image in the image sequence is not included in that additional image;
in response to determining that the mapped endpoint is not included in the additional image, compute the remapped endpoints included in the additional segmented view at least in part by mapping the mapped endpoints of another image in the image sequence onto the additional image; and
compute the additional segmented view at least in part at the image segmentation ML model based at least in part on the remapped endpoints of the additional image.

8. The computing system of claim 2, wherein the one or more processing devices are configured to output the additional segmented views in real time with receiving the image sequence.

9. The computing system of claim 1, wherein the segmented view includes respective annotations of the segmented device components with the text labels.

10. The computing system of claim 1, wherein the one or more processing devices are further configured to:
receive a natural language query;
match the natural language query to a text label of the plurality of text labels; and
in response to matching the natural language query to the text label, modify the segmented view to visually indicate a segmented device component associated with the text label.

11. The computing system of claim 1, wherein the one or more processing devices are further configured to:
based at least in part on the identification of the segmented device components, identify a defect in a segmented device component of the plurality of segmented device components; and
output the identification of the defect for display at the display device.

12. A method for use with a computing system that includes an imaging sensor, a display device, and one or more processing devices, the method comprising, at the one or more processing devices:
receiving a schematic diagram;
at an optical character recognition (OCR) machine learning (ML) model, extracting a plurality of text labels from the schematic diagram;
at a line detection ML model, extracting a plurality of reference lines associated with the text labels from the schematic diagram;
computing a plurality of schematic annotation pairs that each include:
a text label of the plurality of text labels; and
a reference line endpoint located at an opposite end, relative to the text label, of a corresponding reference line of the plurality of reference lines;
receiving a first image from the imaging sensor;
at least in part by executing an image matching ML model, computing a multi-point mapping between the reference line endpoints and respective mapped endpoints included in the first image;
at least in part by executing an image segmentation ML model, identifying a plurality of segmented device components within the first image based at least in part on the multi-point mapping;
computing a segmented view of the first image that depicts one or more of the segmented device components in a visually distinguishable manner; and
outputting the segmented view for display at the display device.

13. The method of claim 12, further comprising:
receiving, from the imaging sensor, an image sequence including a plurality of images, wherein the image sequence begins with the first image;
for each of the images in the image sequence after the first image, computing an additional segmented view;
outputting the additional segmented views for display at the display device.

14. The method of claim 13, wherein the segmented view and the additional segmented views each include a respective plurality of two-dimensional (2D) masks that overlay the segmented device components.

15. The method of claim 14, further comprising:
computing respective sets of 3D Gaussian splats associated with the images included in the image sequence; and
for each of the images, computing respective 3D masks based at least in part on 3D Gaussian splats; and
computing the rendered 2D masks based at least in part on the 3D masks.

16. The method of claim 13, wherein computing the segmented view includes:
computing a fundamental matrix between the schematic diagram and the first image;
for each of the mapped endpoints identified in the first image, computing a respective epipolar line through that mapped endpoint based at least in part on the fundamental matrix;
computing a plurality of remapped endpoints based at least in part on the epipolar line; and
computing the segmented view at least in part at the image segmentation ML model based at least in part on the remapped endpoints.

17. The method of claim 13, wherein the additional segmented views are output in real time with receiving the image sequence.

18. The method of claim 12, wherein the segmented view includes respective annotations of the segmented device components with the text labels.

19. The method of claim 12, further comprising:
receiving a natural language query;
matching the natural language query to a text label of the plurality of text labels; and
in response to matching the natural language query to the text label, modifying the segmented view to visually indicate a segmented device component associated with the text label.

20. A computing system comprising:
an imaging sensor;
a display device; and
one or more processing devices configured to:
receive a schematic diagram;
at an optical character recognition (OCR) machine learning (ML) model, extract a plurality of text labels from the schematic diagram;
detect a plurality of reference line endpoints included in the schematic diagram;
associate each of the reference line endpoints with a corresponding text label of the plurality of text labels;
receive, from the imaging sensor, an image sequence including a plurality of images;
for each of the images included in the image sequence:
at least in part by executing an image matching ML model, compute a multi-point mapping between the reference line endpoints and respective mapped endpoints included in the first image;
at least in part by executing an image segmentation ML model, identify a plurality of segmented device components within the first image based at least in part on the multi-point mapping;
compute a segmented view of the first image that depicts the segmented device components and respective annotations of the segmented device components with the text labels; and
output the segmented view for display at the display device.
